(19) United States
(12) Patent Application Publication
(10) Pub. No.: US 2023/0311698 A1
(43) Pub. Date: Oct. 5, 2023

(54) CHARGE MANAGEMENT SYSTEM

(71) Applicant: HONDA MOTOR CO., LTD., Tokyo (JP)

(72) Inventor: Akira SAITA, Tokyo (JP)

(73) Assignee: HONDA MOTOR CO., LTD., Tokyo (JP)

(21) Appl. No.: 18/127,411

(22) Filed: Mar. 28, 2023

(30) Foreign Application Priority Data
Mar. 29, 2022 (JP) 2022-054066

(51) Int. Cl. B60L 53/66; H02J 7/00; B60L 58/12; G06Q 10/02

(52) U.S. Cl. CPC B60L 53/66; H02J 7/0048; B60L 58/12; H02J 7/0071; G06Q 10/02

(57) ABSTRACT

A charge management system for a battery mounted on an electric vehicle includes processing circuitry configured to: acquire charge-related information that is information on whether charge is possible; acquire power consumption history of the battery; predict a future SOC of the battery based on the power consumption history; set a scheduled charge date when a predicted SOC value of the battery is predicted to decrease to a threshold or less; and notify the scheduled charge date. The processing circuitry sets the scheduled charge date based on the charge-related information.

### CROSS-REFERENCE TO RELATED APPLICATIONS

This application is based on and claims priority under 35 USC 119 from Japanese Patent Application No. 2022-054066 filed on Mar. 29, 2022, the entire content of which is incorporated herein by reference.

### TECHNICAL FIELD

The present invention relates to a charge management system mounted on an electric vehicle.

### BACKGROUND ART

In recent years, research and development on power-charging/supplying of a vehicle on which a secondary battery is mounted that contributes to improvement in energy efficiency have been carried out to secure access to affordable, reliable, sustainable, and modern energy for more people.

Incidentally, in the power-charging/supplying of the vehicle on which the secondary battery is mounted, for example, JP2011-169663A discloses that charge is prompted by notifying that a SOC of a battery has decreased to a predetermined amount. Further, JP2021-197862A and JP2020-94838A disclose that a charge plan is made by predicting a future SOC.

However, in the techniques disclosed in JP2011-169663A, JP2021-197862A, and JP2020-94838A, even if a user receives a notification and wants to perform charge, a schedule may conflict, charge equipment may be in use, or weather may not be suitable for the charge due to bad weather.

An aspect of the present disclosure relates to provide a charge management system that can reduce occurrence of a situation where charge cannot be performed on a notified scheduled charge date. The present invention contributes to the improvement in the energy efficiency.

### SUMMARY OF INVENTION

According to an aspect of the present disclosure, there is provided a charge management system for a battery mounted on an electric vehicle includes processing circuitry configured to: acquire charge-related information that is information on whether charge is possible; acquire power consumption history of the battery; predict a future SOC of the battery based on the power consumption history; set a scheduled charge date when a predicted SOC value of the battery is predicted to decrease to a threshold or less, and notify the scheduled charge date. The processing circuitry sets the scheduled charge date based on the charge-related information.

### BRIEF DESCRIPTION OF DRAWINGS

FIG. 1 is a diagram showing a relationship among a vehicle 1 on which a battery 11 is mounted, a management server 2 that constitutes a charge management system 21, and a portable terminal 3 of a user;

FIG. 2 is a block diagram of the charge management system 21;

FIG. 3 is a flowchart of registration of power consumption history; and

FIG. 4 is a flowchart of execution of a charge reservation.

### DESCRIPTION OF EMBODIMENTS

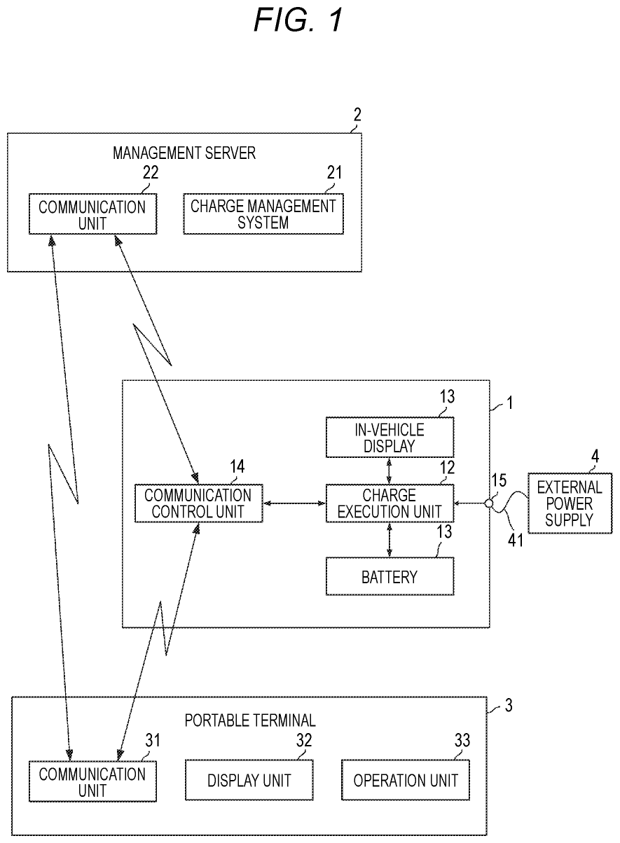

Hereinafter, an embodiment of the present invention will be described with reference to FIGS. 1 to 4.

FIG. 1 is a diagram showing a relationship among a vehicle 1 on which a battery 11 is mounted, a management server 2 that constitutes a charge management system 21, and a portable terminal 3 of a user. In the present embodiment, the charge management system 21 is mounted on the management server 2, but the charge management system 21 may be mounted on the vehicle 1 or the portable terminal 3, or may be dispersedly mounted on the vehicle 1, the management server 2, and the portable terminal 3.

In the present embodiment, the vehicle may be any vehicle as long as the vehicle can be moved by a power supply from a battery. Therefore, the present embodiment can be applied to various vehicles such as a two-wheeled vehicle, a three-wheeled vehicle, and a four-wheeled vehicle. The vehicle includes an electric vehicle that travels by a power supply from a battery, and a hybrid vehicle including a motor that performs driving by receiving the power supply from the battery and an internal combustion engine.

As shown in FIG. 1, the vehicle 1 includes a battery 11, a charge execution unit 12, an in-vehicle display 13, a communication control unit 14, and a charge port 15. An external power supply 4 is, for example, charge equipment installed in a charge station located near home of the user of the vehicle 1. After the vehicle 1 arrives at the charge station, the user performs charge from the external power supply 4 to the battery 11 by inserting a charge connector (charge gun) provided at a tip end of a cable 41 that extends from the external power supply 4 into the charge port 15. In the present embodiment, a case where the battery 11 is charged from the external power supply 4 by the plug-in method has been described, but the battery 11 may be charged from the external power supply 4 by a non-contact power supply method.

When the charge connector is connected to the charge port 15, the charge execution unit 12 executes charge from the external power supply 4 to the battery 11 according to control from the management server 2. Further, the charge execution unit 12 can acquire various pieces of information on the vehicle 1 including the battery 11 (for example, a state of charge (SOC) that is a remaining capacity of the battery 11, a temperature of the battery 11 (hereinafter, referred to as a battery temperature)), and an outside air temperature of the vehicle 1 by using various sensors.

The in-vehicle display 13 is a navigation device or the like provided in the vehicle 1. Therefore, the in-vehicle display 13 can display the various pieces of information as images and output the information as sound. Further, the in-vehicle display 13 includes an operation unit such as a touch panel that receives an operation input from the user.

The communication control unit 14 can transmit and receive information to and from the management server 2 and the portable terminal 3 by wireless communication. For example, the communication control unit 14 receives an instruction content related to charge control of the battery 11 from the management server 2 and outputs the instruction content to the charge execution unit 12, and transmits various pieces of information on the battery 11 acquired by the charge execution unit 12 to the management server 2.

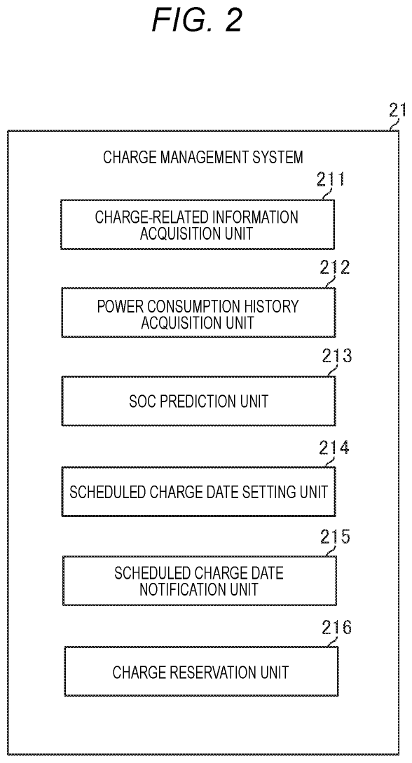

The management server 2 includes the charge management system 21 and a communication unit 22. The charge management system 21 includes hardware including a control processor such as a CPU and a storage device such as a ROM, a RAM, and storage, and software such as a charge management program stored in the ROM or the storage. As shown in FIG. 2, the charge management system 21 includes a charge-related information acquisition unit 211, a power consumption history acquisition unit 212, a SOC prediction unit 213, a scheduled charge date setting unit 214, a scheduled charge date notification unit 215, and a charge reservation unit 216 as functional configurations implemented by cooperation between the hardware and the software. These functional configurations will be described later.

The communication unit 22 can transmit and receive information to and from the communication control unit 14 of the vehicle 1 and the portable terminal 3 by the wireless communication. For example, the communication unit 22 receives the various pieces of information on the vehicle 1 (for example, the SOC of the battery 11, the battery temperature, and the outside air temperature of the vehicle 1) from the communication control unit 14.

The portable terminal 3 is, for example, a smart device such as a smartphone, and includes a communication unit 31, a display unit 32, and an operation unit 33. The communication unit 31 can transmit and receive information to and from the communication unit 22 of the management server 2 and the communication control unit 14 of the vehicle 1 by the wireless communication. The display unit 32 displays various pieces of information as images. The operation unit 33 is a touch panel or the like that receives an operation input from the user.

Next, functional configurations of the charge management system 21 will be described.

The power consumption history acquisition unit 212 acquires power consumption history of the battery 11. For example, SOC at the time of departing from home and SOC at the time of returning home are acquired from the charge execution unit 12 of the vehicle 1, a SOC consumption amount (%/day) used in one day (hereinafter, referred to as ΔSOC as appropriate) is calculated from a difference thereof, and the ΔSOC is registered in the storage unit in association with date data.

Based on the power consumption history, the SOC prediction unit 213 estimates a SOC consumption amount consumed in one day after the next day (hereinafter, referred to as an estimated ΔSOC as appropriate). For example, the estimated ΔSOC after the next day is calculated by statistical estimation based on the power consumption history. The estimated ΔSOC is, for example, an average value of ΔSOC in a predetermined period such as a past week.

The charge-related information acquisition unit 211 acquires charge-related information that is information on whether charge is possible. Specifically, the charge-related information includes at least one of a schedule of the user, pre-registered information of charge equipment in a charge station, and weather information of a charge site.

A reason why the schedule of the user is included in the charge-related information is that there may be a situation where charge cannot be performed such as a case where the user is far away from the charge station due to a trip or the like. When the charge-related information is the schedule of the user, the charge-related information acquisition unit 211 acquires schedule information of the user in cooperation with pre-registered schedule information in the management server 2. For example, the charge-related information acquisition unit 211 acquires departure/arrival scheduled date and time of the trip, a schedule of going out, and the like registered in the portable terminal 3.

When the schedule information of the user is stored in the portable terminal 3 or another server, the charge-related information acquisition unit 211 may communicate with the portable terminal 3 or the other server via the wireless communication, and acquire the schedule information of the user. Further, when the schedule information of the user is stored in the navigation device provided in the vehicle 1, the charge-related information acquisition unit 211 may acquire the schedule information of the user from the navigation device.

A reason why the information of the charge equipment in the charge station is included in the charge-related information is that there may be a situation where the charge cannot be performed such as a case where maintenance of the charge equipment is scheduled when reservation of the charge equipment in the charge station has already been made. When the charge-related information is the information of the charge equipment in the charge station, the charge-related information acquisition unit 211 acquires charge equipment information of the charge station in cooperation with the charge equipment information of the charge station.

A reason why the weather information of the charge site is included in the charge-related information is that there may be a situation where the charge cannot be performed such as a case of a typhoon or a thunderstorm forecast. Further, this is also because the user usually tends not to perform charge during rough weather or hot weather, and therefore it is preferable to guide the user to perform charge in weather suitable for charge as much as possible. When the charge-related information is the weather information, the charge-related information acquisition unit 211 acquires weather information at the time of charge in cooperation with a weather information server.

The scheduled charge date setting unit 214 temporarily determines a scheduled charge date based on the estimated ΔSOC calculated by the SOC prediction unit 213, and further sets the scheduled charge date based on the above-described charge-related information. More specifically, the scheduled charge date setting unit 214 subtracts the calculated estimated ΔSOC from a current SOC for each day to estimate a date (expected date) on which a predicted SOC value is equal to or smaller than the threshold SOC, and sets the expected date as a temporarily scheduled charge date. The scheduled charge date setting unit 214 determines whether charge is possible on the temporarily scheduled charge date based on the charge-related information, and if the charge is possible, sets the date as the scheduled charge date. On the other hand, when the charge is not possible on the temporarily scheduled charge date, for example, if the charge is possible on a date before the temporarily scheduled charge date, the scheduled charge date setting unit 214 sets the date before the temporarily scheduled charge date as the scheduled charge date. The scheduled charge date setting unit 214 preferably also sets a charge time zone of the scheduled charge date.

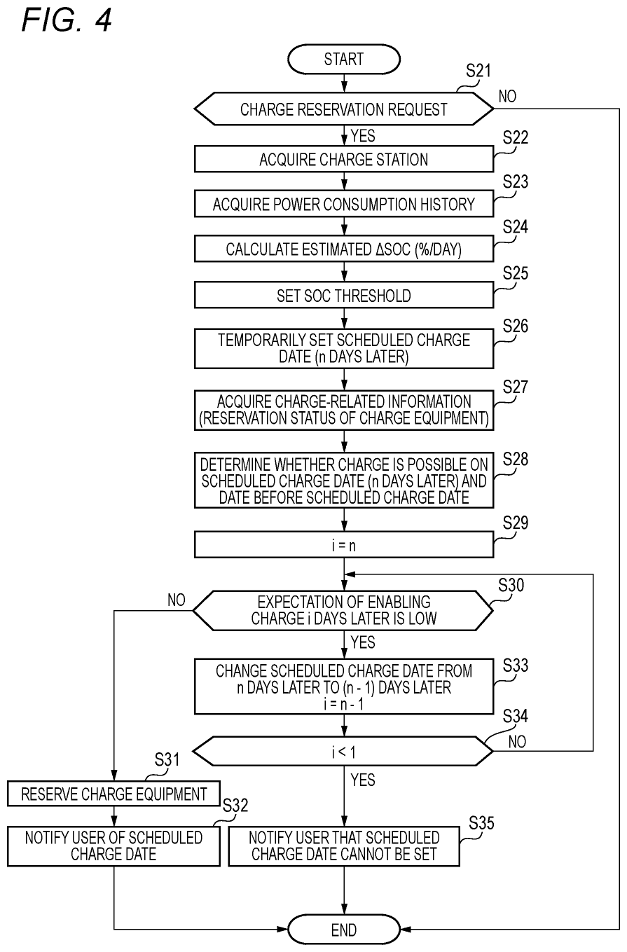

The threshold SOC may be a threshold for performing a charge recommendation notification, may be a lower limit value (for example, 0%) of the SOC, or may be a set value set to prevent deterioration of the battery 11. Further, the threshold SOC may be freely set by the user, or may be set by the charge management system 21 based on the power consumption history. FIG. 4 exemplifies a case where the charge management system 21 sets the threshold SOC based on the power consumption history.

The scheduled charge date setting unit 214 may select a plurality of candidate dates earlier than the expected date on which the predicted SOC value of the battery is equal to or smaller than the threshold SOC, and may set an optimum scheduled charge date from the plurality of candidate dates based on the charge-related information.

The scheduled charge date notification unit 215 notifies the in-vehicle display 13 or the portable terminal 3 of the scheduled charge date set by the scheduled charge date setting unit 214.

The charge reservation unit 216 reserves the charge equipment in the charge station on the scheduled charge date set by the scheduled charge date setting unit 214 before notifying the user of the scheduled charge date.

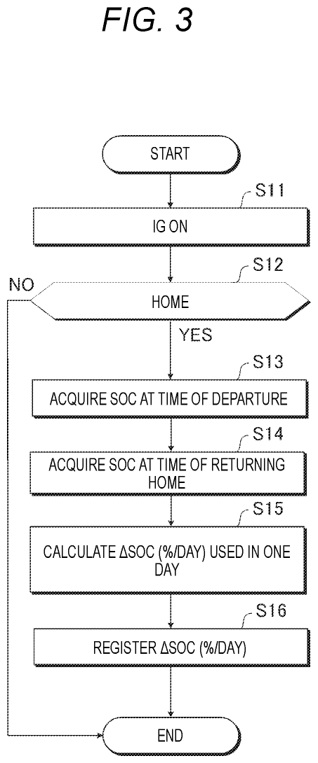

Next, a specific process procedure of the charge management system 21 will be described with reference to FIGS. 3 and 4. FIG. 3 is a flowchart of registration of the power consumption history. FIG. 4 is a flowchart of execution of a charge reservation.

In the registration of the power consumption history shown in FIG. 3, the charge management system 21 determines whether an ignition switch of the vehicle 1 is ON (S11) and determines whether a position of the vehicle 1 is home (S12). When a determination result of any one of the determinations is NO, the charge management system 21 ends the process. When both determination results of step S11 and step S12 are YES, the charge management system 21 acquires a SOC at the time of departure (S13). Further, the charge management system 21 acquires a SOC at the time of returning home during home-returning (S14). The charge management system 21 calculates a ΔSOC (%/day) consumed in one day (S15), and registers the calculated ΔSOC in the storage unit in association with the date data (S16).

In the execution of the charge reservation shown in FIG. 4, the charge management system 21 determines whether there is a charge reservation request from the user (S21). When there is no charge reservation request (NO in S21), the charge management system 21 ends the process. When there is the charge reservation request (YES in S21), the charge management system 21 acquires a pre-registered charge station (S22). Subsequently, the charge management system 21 acquires power consumption history (S23), calculates an estimated ΔSOC (%/day) that is a SOC consumption amount consumed in one day after the next day (S24), and sets a SOC threshold (S25). The charge management system 21 subtracts the estimated ΔSOC from a current SOC for each day to estimate a date (expected date) on which a predicted SOC value is equal to or smaller than a threshold SOC, and temporarily sets the expected date as a temporarily scheduled charge date (S26). The scheduled charge date corresponds to n days after a date on which the charge reservation request is made (n>1).

The charge management system 21 acquires a reservation status as charge-related information of the pre-registered charge station acquired in step S22 (S27). As described above, the charge management system 21 may acquire the schedule of the user and the weather information in addition to the reservation status of the charge station as the charge-related information. Further, the charge management system 21 may acquire the schedule of the user, the weather information, and the like instead of the reservation status of the charge station.

Based on the charge-related information, the charge management system 21 determines whether charge is possible on the scheduled charge date (n days later) and a date before the scheduled charge date (S28). That is, the charge management system 21 sets i=n (S29), and determines whether expectation of enabling the charge i days later is low (i=n) (S30). As a result, when the expectation of enabling the charge is high (NO in S30), the charge management system 21 reserves the charge equipment (S31), and notifies the user of the scheduled charge date (n days later) (S32).

On the other hand, in step S30, when the expectation of enabling the charge i days later (i=n) is low (YES in S30), the charge management system 21 changes the scheduled charge date from n days later to (n−1) days later (S33). Subsequently, the charge management system 21 determines whether i=n−1 is smaller than 1 (S34). When i=n−1 is larger than 1 (NO in S34), the charge management system 21 determines whether the expectation of enabling the charge i days later (i=n−1) is low this time (S30).

Thereafter, the processes of steps S30, S33, and S34 are repeated until a date on which the expectation of enabling the charge is high is set or i<1. If the date on which the expectation of enabling the charge is high is found (NO in S30), the charge management system 21 reserves the charge equipment (S31), and notifies the user of the scheduled charge date (i days later) (S32). On the other hand, when the date on which the expectation of enabling the charge is high is not found and i<1 (YES in S34), the charge management system 21 notifies the user that the scheduled charge date cannot be set, and ends the process.

As described above, according to the execution of the charge reservation of the present embodiment, the scheduled charge date is set based on the charge-related information that is information on whether the charge is possible, so that occurrence of a situation where the charge cannot be performed on the notified scheduled charge date can be reduced. Further, since the scheduled charge date can be set according to the schedule of the user, the reservation status of the charge equipment, the weather information, and the like, it is possible to determine whether the charge is possible in more details. Furthermore, since the charge equipment is reserved prior to the charge notification, it is possible to save a trouble of reserving the charge equipment by the user himself/herself.

For example, in the execution of the charge reservation in FIG. 4, the charge management system 21 may reserve the charge equipment when obtaining acceptance of the user after notifying the user of the scheduled charge date.

The user may set a charge schedule in advance. For example, a charge date may be set only on weekends in a week, or charge date and time may be set only in morning on weekdays.

In the present specification, at least the following matters are described. Although corresponding constituent elements or the like in the above-described embodiment are shown in parentheses, the present invention is not limited thereto.

(1) A charge management system (the charge management system 21) for a battery (the battery 11) mounted on an electric vehicle (the vehicle 1), the charge management system including:
a charge-related information acquisition unit (the charge-related information acquisition unit 211) configured to acquire charge-related information that is information on whether charge is possible;
a power consumption history acquisition unit (the power consumption history acquisition unit 212) configured to acquire power consumption history of the battery;
a SOC prediction unit (the SOC prediction unit 213) configured to predict a future SOC of the battery based on the power consumption history;
a scheduled charge date setting unit (the scheduled charge date setting unit 214) configured to set a scheduled charge date when a predicted SOC value of the battery is predicted to decrease to a threshold or less; and
a scheduled charge date notification unit (the scheduled charge date notification unit 215) configured to notify the scheduled charge date,
in which the scheduled charge date setting unit sets the scheduled charge date based on the charge-related information.

According to (1), the scheduled charge date is set based on the charge-related information that is the information on whether the charge is possible, so that occurrence of a situation where the charge cannot be performed on the notified scheduled charge date can be reduced.

(2) The charge management system according to (1),
in which the charge-related information includes information on a schedule of a user, and
in which the scheduled charge date setting unit sets the scheduled charge date based on the schedule of the user.

According to (2), the scheduled charge date can be set according to the schedule of the user.

(3) The charge management system according to (1) or (2),
in which the charge-related information includes information on a reservation status of charge equipment, and
in which the scheduled charge date setting unit sets the scheduled charge date based on the reservation status of the charge equipment.

According to (3), the scheduled charge date can be set according to the reservation status of the charge equipment.

(4) The charge management system according to (3), further including:
a charge reservation unit (the charge reservation unit 216) configured to reserve the charge equipment,
in which the charge reservation unit reserves the charge equipment before notifying the user of the scheduled charge date.

According to (4), since the charge equipment is reserved prior to the charge notification, it is possible to save a trouble of reserving the charge equipment by the user himself/herself.

(5) The charge management system according to any one of (1) to (4),
in which the charge-related information includes weather information of a charge site, and
in which the scheduled charge date setting unit sets the scheduled charge date based on the weather information.

According to (5), the scheduled charge date can be set according to the weather information.

(6) The charge management system according to any one of (1) to (5),
in which the scheduled charge date setting unit selects a plurality of candidate dates earlier than an expected date on which a predicted SOC value of the battery decreases to a threshold or less, and sets the scheduled charge date from the plurality of candidate dates.

According to (6), a scheduled charge date according to life or preference of the user can be set.

What is claimed is:

1. A charge management system for a battery mounted on an electric vehicle, the charge management system comprising
processing circuitry configured to:
acquire charge-related information that is information on whether charge is possible;
acquire power consumption history of the battery;
predict a future SOC of the battery based on the power consumption history;
set a scheduled charge date when a predicted SOC value of the battery is predicted to decrease to a threshold or less; and
notify the scheduled charge date,
wherein the processing circuitry sets the scheduled charge date based on the charge-related information.

2. The charge management system according to claim 1,
wherein the charge-related information includes information on a schedule of a user, and
wherein the processing circuitry sets the scheduled charge date based on the schedule of the user.

3. The charge management system according to claim 1,
wherein the charge-related information includes information on a reservation status of charge equipment, and
wherein the processing circuitry sets the scheduled charge date based on the reservation status of the charge equipment.

4. The charge management system according to claim 3,
wherein the processing circuitry is further configured to reserve the charge equipment before notifying the user of the scheduled charge date.

5. The charge management system according to claim 1,
wherein the charge-related information includes weather information of a charge site, and
wherein the processing circuitry sets the scheduled charge date based on the weather information.

6. The charge management system according to claim 1,
wherein the processing circuitry selects a plurality of candidate dates earlier than an expected date on which a predicted SOC value of the battery decreases to a threshold or less, and sets the scheduled charge date from the plurality of candidate dates.
